(19) United States
(12) Patent Application Publication
(10) Pub. No.: US 2007/0139960 A1
(43) Pub. Date: Jun. 21, 2007

(54) Light guide plate having dammann grating structure at surface thereof and backlight module and liquid crystal display having same

(75) Inventor: Ming-Hung Tsai, MiaoLi (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/638,875

(22) Filed: Dec. 14, 2006

(30) Foreign Application Priority Data
Dec. 16, 2005 (CN) 200510120725.5

(51) Int. Cl. F21V 7/04

(52) U.S. Cl. 362/608; 362/625

(57) ABSTRACT

An exemplary light guide plate (14) includes a light incident surface (140), a light emitting surface (142) adjacent the light incident surface, a bottom surface (144) opposite to the light emitting surface, and a plurality of side surfaces (146, 148) between the light emitting surface and the bottom surface. At least one dammann grating structure (149) is provided at at least one of the bottom surface and the side surfaces.

### FIELD OF THE INVENTION

The present invention relates to light guide plates for backlight modules such as those used in liquid crystal displays (LCDs). More particularly, the present invention relates to a light guide plate having a plurality of dammann grating structures formed at one or more surfaces thereof, a backlight module including the light guide plate, and a liquid crystal display including the backlight module.

### GENERAL BACKGROUND

Liquid crystal displays are commonly used as displays for compact electronic apparatuses, because they not only provide good quality images with little power but are also very thin. The liquid crystal in a liquid crystal display does not emit any light itself. The liquid crystal has to be lit by a light source so as to clearly and sharply display text and images. Thus, a backlight module is generally needed for a liquid crystal display.

A light guide plate is generally used in a backlight module for converting one or more point light sources or linear light sources into a surface light source. In a typical light guide plate, a plurality of diffusing dots are formed at a bottom surface thereof. The diffusing dots can diffuse light beams incident thereon, which helps the backlight module achieve uniform emission of light. A diffusing film is generally used in the backlight module above a top output surface of the light guide plate. The diffusing film further improves the uniformity of light emission of the backlight module.

The distribution of the diffusing dots is generally determined by theoretical calculations. However, stray light or light leakage is liable to occur due to imprecise manufacturing of the light guide plate. When this happens, the actual light emission of the backlight module may not be uniform. Further, the need for the diffusing film adds to the cost of the backlight module.

What is needed, therefore, is a light guide plate that can overcome the above-described deficiencies. What is also needed is a backlight module employing the light guide plate. What is further need is a liquid crystal display employing the backlight module.

### SUMMARY

In one preferred embodiment, a light guide plate includes a light incident surface, a light emitting surface adjacent the light incident surface, a bottom surface opposite to the light emitting surface, and a plurality of side surfaces between the light emitting surface and the bottom surface. At least one dammann grating structure is provided at at least one of the bottom surface and the side surfaces.

Other aspects, advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the described embodiments. In the drawings, like reference numerals designate corresponding parts throughout various views, and all the views are schematic.

FIG. 1 is an exploded, side view of a liquid crystal display according to an exemplary embodiment of the present invention, the liquid crystal display including a backlight module.

FIG. 2 is an exploded, isometric view of the backlight module of FIG. 1, the backlight module including a light guide plate having a plurality of dammann grating structures (only one partially shown) formed at certain surfaces thereof.

FIG. 3 is an enlarged, plan view of a portion of one of the surfaces of the light guide plate of FIG. 2 that has a dammann grating structure formed thereon.

### DETAILED DESCRIPTION OF PREFERRED EMBODIMENTS

Reference will now be made to the drawings to describe the preferred embodiments in detail.

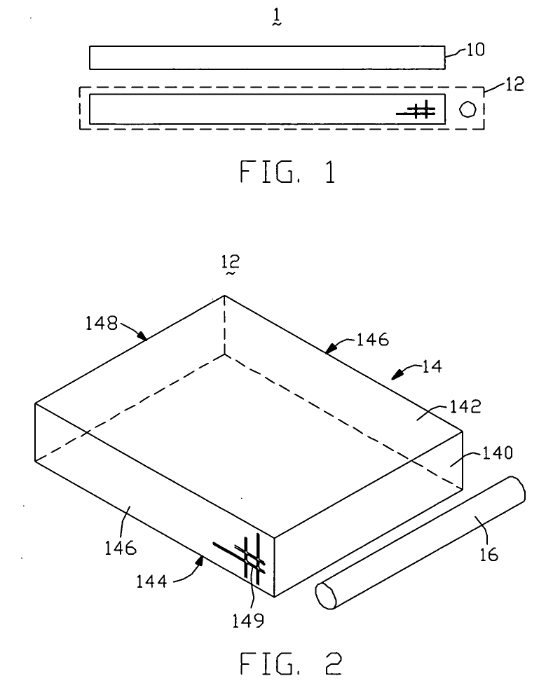

Referring to FIG. 1, a liquid crystal display 1 according to an exemplary embodiment of the present invention is shown. The liquid crystal display 1 includes a liquid crystal panel 10, and a backlight module 12 located adjacent to the liquid crystal panel 10.

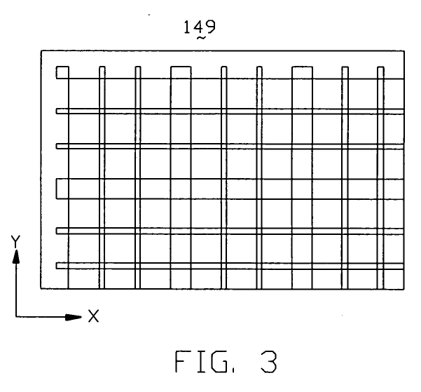

Referring also to FIG. 2, the backlight module 12 includes a light guide plate 14 and a light source 16. The light guide plate 14 includes a light incident surface 140, a light emitting surface 142, a bottom surface 144, two first side surfaces 146, and a second side surface 148. The light emitting surface 142 is perpendicularly connected with the light incident surface 140. The bottom surface 144 is opposite to the light emitting surface 142. The first side surfaces 146 are opposite to each other, and are connected with the light incident surface 140. The second side surface 148 is opposite to the light incident surface 140. The light incident surface 140, the first side surfaces 146, and the second side surface 148 are between the light emitting surface 142 and the bottom surface 144. The light guide plate 14 can for example be made from polycarbonate (PC) or polymethyl methacrylate (PMMA), and can be manufactured by an injection molding method. The liquid crystal panel 10 is located adjacent to the light emitting surface 142 of the light guide plate 14. The light source 16 is located adjacent to the light incident surface 140 of the light guide plate 14. In the illustrated embodiment, the light source 16 is a cold cathode fluorescent lamp (CCFL).

The light guide plate 14 further includes a plurality of so-called reflective dammann grating structures 149 respectively formed at the bottom surface 144, the first side surfaces 146, and the second side surface 148. That is, the dammann grating structures 149 are formed at surfaces of the light guide plate 14 except the light incident surface 140 and the light emitting surface 142. In the illustrated embodiment, each dammann grating structure 149 is in the form of a plurality of micro-sized grooves defined in the relevant surface 144, 146, 148 and spanning substantially an entire expanse of the surface 144, 146, 148. The grooves are arrayed in a two-dimensional crisscross matrix. A plurality of micro-surfaces that define the grooves of the surface 144, 146, 148 are coated with reflective layers, thereby forming the dammann grating structure. Light beams striking the dammann grating structure 149 can be refracted and reflected at uniform angular intervals and with uniform brightness. The dammann grating structures 149 can be integrally formed with the light guide plate 14 by an injection molding method, or formed by a hot embossing method after a preform of the light guide plate 14 is manufactured.

Referring to also FIG. 3, for each dammann grating structure 149, optical characteristics in an X direction and in a Y direction perpendicular to the X direction are each governed by the following equation (1):

$$sin {θ}_{n} = sin {θ}_{i} + n \frac{λ}{Λ} \qquad ( 1 )$$

wherein n represents a diffraction level of a diffracted light beam, θₙ represents a diffraction angle of the diffracted light beam of level n, θᵢ represents an incident angle of an incident light beam, λ represents a wavelength of the incident light beam, and Λ represents a period of the dammann grating structure 149.

Because of the relationship between the diffraction angle θₙ and the wavelength λ, the period Λ is governed by the following inequality (2) in order to prevent seriously identifiable dispersion of the diffracted light beams:

$$Λ \geq \frac{n Δλ}{Δθ} \qquad ( 2 )$$

wherein Δθ represents a difference between diffraction angles of the diffracted light beams of level n at two ends of the light beams in the visible region, each diffraction angle of the light beams in the visible region being less than 1.15 degrees, and Δλ represents a difference between the wavelengths of the light beams at the two ends of the visible region. That is, Δλ is 4×10⁻⁷ m.

In operation, light beams are emitted from the light source 16, and transmit into the light guide plate 14 through the light incident surface 140. The light beams are refracted and reflected after they strike the dammann grating structures 149 at the bottom surface 144, the first side surfaces 146, and the second side surface 148. The dammann grating structures 149 have the function of splitting light, such that when one light beam penetrates each dammann grating structure 149 twice, it can be diffracted into n×n light beams with a same brightness. Thus, a multiplicity of multidirectional individual light beams can be obtained after the incident light beams are refracted and reflected by the dammann grating structures 149. The combined effect of these light beams enables the light emitting surface 142 of the light guide plate 14 to achieve greatly improved uniform emission of light beams.

In summary, the backlight module 12 includes the plurality of dammann grating structures 149 formed at the surfaces 144, 146, 148 of the light guide plate 14, which can greatly improve a uniformity of emission of light from the backlight module 12. Thus the backlight module 12 can achieve desired optimized optical performance without the need for a conventional diffusing film. Therefore, the cost of the backlight module 12 and the liquid crystal display 1 can be reduced.

Further or alternative embodiments may include the following. In one example, the light source 16 can be replaced by one or more light emitting diodes (LEDs). In another example, the light guide plate 14 can further include a plurality of prism structures at the light emitting surface 142, for improving a brightness of the backlight module 12 and the associated liquid crystal display 1. In a further example, the dammann grating structures 149 can be formed only at one or two selected of the surfaces 144, 146, 148 of the light guide plate 14. In a still further example, only a part of each surface 144, 146, 148 of the light guide plate 14 may be provided with a dammann grating structure 149.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light guide plate comprising:
a light incident surface;
a light emitting surface adjacent the light incident surface;
a bottom surface opposite to the light emitting surface; and
a plurality of side surfaces between the light emitting surface and the bottom surface;
wherein at least one dammann grating structure is provided at at least one of the bottom surface and the side surfaces.

2. The light guide plate in claim 1, wherein the at least one dammann grating structure is in the form of a plurality of grooves defined in the at least one of the bottom surface and the side surfaces.

3. The light guide plate in claim 2, wherein a plurality of micro-surfaces of the at least one of the bottom surface and the side surfaces that define the grooves are coated with one or more reflective layers.

4. The light guide plate in claim 1, wherein the at least one dammann grating structure spans substantially an entirety of the at least one of the bottom surface and the side surfaces.

5. The light guide plate in claim 1, wherein the at least one dammann grating structure is arrayed in a two-dimensional crisscross matrix.

6. The light guide plate in claim 5, wherein a period of the at least one dammann grating structure in one direction thereof is greater than or equal to nΔλ/Δθ, Δθ representing a difference between diffraction angles of diffracted light beams of level n at two ends of the light beams in the visible region, and Δλ representing a difference between the wavelengths of the light beams at the two ends of the visible region.

7. The light guide plate in claim 6, wherein each diffraction angle of the visible light beams is less than 1.15 degrees.

8. The light guide plate in claim 1, wherein the light guide plate is an injection molded light guide plate having the at least one dammann grating structure forming part of a main body of the light guide plate at the at least one of the bottom surface and the side surfaces, or the at least one dammann grating structure is a hot embossed at least one dammann grating structure.

9. The light guide plate in claim 1, wherein the light guide plate including the at least one dammann grating structure is made from polycarbonate or polymethyl methacrylate.

10. A backlight module comprising:
a light guide plate comprising:
a light incident surface;
a light emitting surface adjacent the light incident surface;
a bottom surface opposite to the light emitting surface; and
a plurality of side surfaces between the light emitting surface and the bottom surface; and
a light source located adjacent to the light incident surface;
wherein at least one dammann grating structure is provided at at least one of the bottom surface and the side surfaces.

11. The backlight module in claim 10, wherein the at least one dammann grating structures is in the form of a plurality of grooves defined in the at least one of the bottom surface and the side surfaces.

12. The backlight module in claim 11, wherein a plurality of micro-surfaces of the at least one of the bottom surface and the side surfaces that define the grooves are coated with one or more reflective layers.

13. The backlight module in claim 10, wherein the at least one the dammann grating structure spans substantially an entirety of the at least one of the bottom surface and the side surfaces.

14. The backlight module in claim 10, wherein the at least one dammann grating structure is arrayed in a two-dimensional crisscross matrix.

15. The backlight module in claim 14, wherein a period of the at least one dammann grating structure in one direction thereof is greater than or equal to nΔλ/Δθ, Δθ representing a difference between diffraction angles of diffracted light beams of level n at two ends of the light beams in the visible region, and Δλ representing a difference between the wavelengths of the light beams at the two ends of the visible region.

16. The backlight module in claim 15, wherein each diffraction angle of the visible light beams is less than 1.15 degrees.

17. A liquid crystal display comprising:
a liquid crystal panel; and
a backlight module located adjacent to the liquid crystal panel, the backlight module comprising:
a light guide plate comprising:
a light incident surface;
a light emitting surface adjacent the light incident surface;
a bottom surface opposite to the light emitting surface; and
a plurality of side surfaces between the light emitting surface and the bottom surface; and
a light source located adjacent to the light incident surface;
wherein at least one dammann grating structure is provided at at least one of the bottom surface and the side surfaces.
